(19) United States
(12) Patent Application Publication
(10) Pub. No.: US 2022/0304892 A1
(43) Pub. Date: Sep. 29, 2022

(54) A PACKAGE FOR SUPPORTING AT LEAST ONE PRODUCT IN PARTICULAR A PHARMACEUTICAL PRODUCT

(71) Applicant: DEENOVA S.R.L., Gragnano Trebbiense (PC) (IT)

(72) Inventors: Fulvio RUDELLO, Gragnano Trebbiense (PC) (IT); Roberto NICHETTI, Gragnano Trebbiense (PC) (IT); Alessandra VERARDO, Gragnano Trebbiense (PC) (IT)

(21) Appl. No.: 17/608,345

(22) PCT Filed: Apr. 30, 2020
(86) PCT No.: PCT/IB2020/054109

§ 371 Date: Nov. 2, 2021

(30) Foreign Application Priority Data
May 3, 2019 (IT) 102019000006527

(51) Int. Cl. A61J 1/10; A61J 1/14; B65D 33/00; B65D 75/58

(52) U.S. Cl. CPC A61J 1/10; A61J 1/1462; B65D 33/001; B65D 75/5805

(57) ABSTRACT

Package for supporting a product, in particular a pharmaceutical product, especially in the form of a package for repackaging said product, and preferably usable in entities, such as hospitals, for the therapeutic care of people, comprising a plurality of elements in which one or more elements are formed as respective supporting elements of the product, and are adapted to support, or contain, the product, and especially formed as a respective sachet. The element package has a corresponding portion, in particular outermost, and preferably upper in use, which is adapted to be connected to at least a respective portion of one or more corresponding elements of the package so as to realize the same package, said connecting portion being adapted to be detached from the respective element of the package, to allow detaching the same element from the remaining part of the package.

### FIELD OF APPLICATION OF THIS INVENTION

The present invention relates to a package for supporting at least one product, in particular a pharmaceutical product.

The present package is especially in the form of a package for repackaging said product, and can preferably be used in entities, such as hospitals, for the therapeutic care of people.

### BACKGROUND

Packages are known for supporting at least one product, in particular a pharmaceutical product, especially in the form of a package for repackaging said product, and preferably usable in entities, such as hospitals, for the therapeutic care of people, which comprise a plurality of elements of the package, in particular in which one or more elements are in the form of respective supporting elements of the product, which are in the form of a respective sachet.

These known packages provide for the use of additional attachment elements for attaching the elements, or sachets, of the package, normally in plastic material, which are inserted through a corresponding hole provided in the elements, or sachets, of the package.

In this way, however, in addition to requiring the use of additional components which have a certain cost and a certain difficulty of arrangement, the opening, or splitting, of the multiple package by operators for the use of the product or drug is extremely difficult. In fact, in order to disassemble the package, the operator must have tools available, such as scissors or the like, to deactivate the additional attachment element, which can often be onerous or difficult for the aforementioned operator to complete.

Furthermore, in the field, there is also a need to obtain an easy and economic attachment between the elements of the package.

Moreover, in the field, there is also a need to obtain an optimal, balanced and suitably durable attachment for said elements of the package.

Furthermore, in the field, there is also a need to avoid creating unwanted breakage of said elements of the package during the various handling phases.

Furthermore, in the field there is also a need to avoid using an excessive number of types of materials on the manufacturing machine of the elements of the package to make the same package, which would make the machine excessively complex and difficult for staff to manage.

### SUMMARY OF THE INVENTION

With the present invention it is wished to propose a new solution and/or an alternative to the solutions known up to now and in particular it is proposed to overcome one or more of the drawbacks or problems referred to above, and/or to satisfy one or more requirements referred to above and/or in any case experienced in the art, and in particular that can be deduced from the above.

A package is therefore provided for supporting at least one product, in particular a pharmaceutical product, especially in the form of a package for repackaging said product, and preferably usable within entities, such as hospitals, for the therapeutic care of people; comprising a plurality of elements of the package, in particular in which plurality one or more elements are in the form of respective supporting elements of the product, preferably in the form of a respective sachet; characterized in that said element of the package has a corresponding portion, in particular outermost, and preferably upper in use, which is adapted to be connected to at least one respective portion of one or more corresponding elements of the package so as to manufacture the same package, said connecting portion being adapted to be detached from the respective element of the package, in particular so as to allow detaching the same element from the remaining part of the package.

In this way, it is possible to quickly and easily separate the various elements of the package from each other, in view of a respective easy use of the product or drug contained therein, in particular without the need to have special tools available to perform such an operation.

### BRIEF DESCRIPTION OF THE DRAWINGS

This and other innovative aspects, or respective advantageous embodiments are, however, set forth in the appended claims, the respective technical characteristics of which can be found, together with corresponding advantages achieved, in the following description, illustrating in detail a purely non-limiting example of the embodiment of the invention, which is made with reference to the appended drawings, in which:

FIG. 1A illustrates a schematic frontal perspective view of a first preferred embodiment of a package according to the present invention, in an empty condition;

FIG. 1B illustrates a schematic rear perspective view of the first preferred embodiment of a package according to the present invention, in an empty condition;

FIG. 1C illustrates a schematic perspective view of the first preferred embodiment of a package according to the present invention, with the respective elements or sachets in a full condition;

FIG. 2 shows a schematic perspective view of a second preferred embodiment of said element of the package, usable for realizing a second preferred embodiment of the package.

### DETAILED DESCRIPTION OF PREFERRED EMBODIMENTS OF THE INVENTION

In the attached figures from 1A to 1C, a first preferred embodiment 10 of a package for supporting at least one product 11, in particular a pharmaceutical product, is illustrated, especially in the form of a package 10 for repackaging said product 11, and preferably usable in entities, such as hospitals, for the therapeutic treatment of people.

As illustrated, the package 10 comprises a plurality of elements 12 of the package, in particular in which a plurality of one or more elements 12 are in the form of respective supporting elements of the product 11, and are preferably adapted to support, i.e. contain, the same product 11, and especially are respectively in the form of a respective sachet 12.

Advantageously, as illustrated, said element of the package 12 has a corresponding portion 120, in particular outermost, and preferably upper in use, which is adapted to be connected to at least a respective portion 120 of one or more corresponding elements of the package 10, so as to realize the same package 10.

With further advantage, said connecting portion 120 is adapted to be detached from the respective element of the package 12, in particular so as to allow detaching the same element 12 from the remaining part of the package 10.

In this way, it is possible to quickly and easily separate the various elements of the package from each other, in view of a respective easy use of the product or drug contained therein, in particular without the need to have special tools available to perform such an operation.

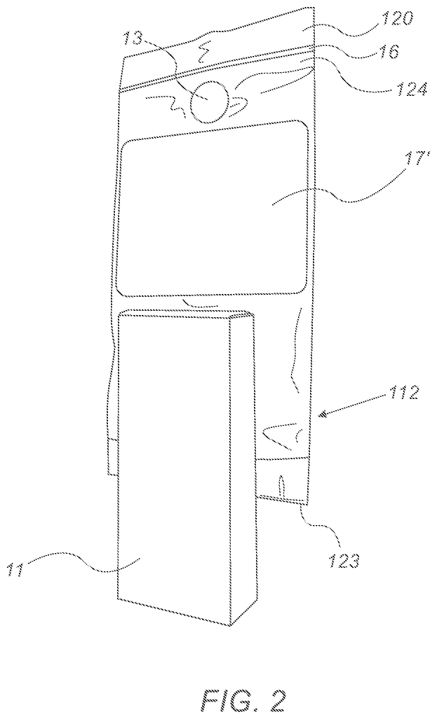

Advantageously, as can be seen in the figures, said element of the package 12 is adapted to contain or, as can be seen in FIG. 2 relating to a second embodiment 112 of the element of the package, which will however be better described in the following of the present description, simply to support the same product 11.

Advantageously, as can be seen in the figures, attachment means 14 are provided for the mutual attachment and retention of the corresponding elements of the package 12.

With advantage, as can be seen in the figures, said mutual attachment and retention means of corresponding elements of the package are applied at the respective detachable connecting portion 120 of the corresponding elements of the package 12.

In this way, by simply removing the detachable connecting portion, the elements of the package are separated, without having to use special tools to deactivate the connection between the same elements of the package.

With particular advantage, as can be seen in the figures, said mutual attachment and retention means of corresponding elements of the package are in the form of clip means 14, in particular a metal clip.

In this way, an easy and economic attachment is obtained between the elements of the package.

Advantageously, as can be seen in the figures, said clip means comprise a single clip 14, in particular in the form of a single metal clip 12.

In this way, an attachment can be obtained that can be performed quickly and easily, as well as particularly inexpensively.

It must however be understood that, although the present preferred embodiment of particularly preferred means of mutual attachment and retention, also other means of mutual attachment and retention different than the one illustrated above would still be imaginable. For example, according to a different embodiment, it could be imagined to sew the elements of the package flush with each other, i.e., to provide for adhering them through corresponding adhesive means or glue points.

In particular, as can be seen in the figures, the respective clip is obtained from a respective wire, in particular a metal wire, and preferably comprises a main portion 141 for engagement with the front face of the front element of the package 12, opposite first and second short portions 142, 143 for insertion into the plurality of said elements of the package 12, which first and second short portions 142, 143 are perpendicular with respect to said main portion 141, and opposite first and second convergent portions 144, 145 for engagement with the rear face of the rear element of the package 12, which first and second convergent portions 144, 145 therebetween extend parallel, or substantially parallel, to said main portion 141 of the clip and extend from said first and said second short insertion portions 142, 143, respectively.

Advantageously, as can be seen from the figures, said clip means 14 are applied in a central or substantially central position, according to the transversal direction, to the corresponding elements of the package 12, i.e., centrally, or substantially centrally, to the corresponding connecting portion 120 and in detail in the middle zone, according to the perpendicular direction, or substantially at half height, of the connecting portion 120.

In this way, an optimal, balanced and suitably durable attachment can be obtained for said elements of the package 12.

In particular, as can be seen in the figures, the respective element of the package 12 comprises means 13, which are adapted to hang the same element of the package to corresponding means for supporting and advancing corresponding storage and supply apparatuses of the package, which are, in particular, in the form of a corresponding hole 13 obtained in the corresponding element of the package 12, preferably near a respective end, in particular a respective upper end in use, and in any case obtained at a central transversal zone of the same element of the package 12.

As illustrated, said hole 13 is provided in the body of the respective element of the package 12, in particular in the zone above it.

With advantage, as can be seen in the figures, said clip means 14 are provided in perpendicular or vertical correspondence with the hole 13 for supporting and moving the package.

As illustrated, the respective clip 14 has a size substantially comparable to that of said hole 13 and preferably the same width as the same hole 13.

In particular, as can be seen in the figures, the element of the package 12 is made of a corresponding film, in particular of a plastic film or a layered film, and is in the form of a sachet 12, which sachet 12 has wide front and rear panels 121, 122, a bottom 123, in particular defined by a welding, especially a transversal welding, between said wide front and rear panels 121, 122, an upper closure 124, in particular defined by a welding, especially a transversal welding, between the same wide front and rear panels 121, 122, and preferably opposite recessed side bellows 125, 126, extending from said wide front and rear panels 121, 122.

In this way, by arranging each element of the package 12, including the element 12′ which bears the label of the package, as will be more evident in the following of the present description, all in the same material, and in the form of a sachet, it is advantageously possible to avoid using different types of materials on the machine for manufacturing the elements of the package 12, which would make the machine excessively complex and difficult for staff to manage.

Advantageously, as can be seen in the figures, the respective element of the package 12 has means 16 for detaching the respective connecting portion 120 from the same element of the package 12, in particular which are adapted to divide said connecting portion 120 from the remainder of the sachet 12, i.e., from the actual sachet.

In this way, it is easy to detach the connecting portion 120 from the rest of the respective element of the package 12, i.e. in particular the complete disassembly of the package can be obtained easily and quickly and without using special tools.

Advantageously, as can be seen in the figures, said means for detaching said connecting portion 120 are in the form of weakening means 16, which are obtained in the material constituting the element of the package 12.

Said weakening means are preferably in the form of a respective weakened line 16, in particular transversal, obtained in the respective element of the package 12, i.e. respectively obtained in said large front and rear panels 121, 122 of the film body of said element of the package 12 and in any side bellows 125, 126 thereof.

With particular advantage, as can be seen in the figures, the weakening means, or line, are obtained above, in use, with respect to the means 13 for hanging the element of the package 12 and/or above, in use, the upper closure 124 of the sachet or supporting element 12, in particular defined by the corresponding welding, especially transversal, between the same wide front and rear panels 121, 122.

In this way, the execution of a precise and accurate detachment of the connecting portion 120 from the rest of the respective element of the package 12 is facilitated, without however damaging the hanging means and/or the integrity of the same sachet or supporting element 12 of the product.

Advantageously, as can be seen in the figures, the weakening means, or line, 16 comprise one or more punched sections 162, 163, i.e., consisting of respective elongated cuts alternating with zones in which the material of the element of the package is intact.

In this way, the execution of a precise and accurate detachment of the connecting portion 120 from the rest of the respective element of the package 12 is facilitated.

With advantage, as can be seen in the figures, the weakening means, or line, 16 have a completely cut central portion, or section, or with a clear separation, 161, and on whose extension opposite first and second punched side portions, or sections 162, 163 are provided.

In particular, said central cut portion, or section, or with a clear separation, 161 extends to a greater extent than the transversal extension of said hanging means, or hole 13.

In this way, the execution of a precise and accurate detachment of the connecting portion 120 from the rest of the respective element of the package 12 is facilitated.

Advantageously, said central cut portion, or section, or with a clear separation, 161 is near the upper edge of said hanging means, or hole 13.

In this way, it is possible to avoid arranging elements of the package 12 which have an excessive length and therefore saving the most amount of material.

Advantageously, as can be seen in said figures, the respective element of the package 12 has, or supports, a respective identification label 17.

In this way, the contents of each element of the package 12 can be known with certainty.

Advantageously, as can be seen in the figures, said identification label 17 is fixed, in particular glued, on the outer face of a corresponding wide panel, especially a front one 121, of said element of the package 12, and/or is preferably in an upper zone, in use, of the same element of the package 12, preferably located above with respect to the perpendicular, or vertical centreline, of the same element of the package 12.

With advantage, as can be seen in said figures, an element of the package 12′ is provided which is adapted to define, or support, the identification tag of the entire package.

Advantageously, as can be seen in the figures, said element of the package 12′ which is adapted to define the tag of the package has a length greater than the respective element of the package 12 which bears said product.

In this way, it can be quickly identified and the contents of the package 12 can be quickly known with certainty.

With particular advantage, as can be seen in the figures, said tag element 12′ of the package, which is adapted to define the tag of the same package, is made of corresponding film, in particular of plastic film or layered film, and is in the form of a corresponding sachet 12, on which an identification label 17′ is provided identifying the package, which is fixed, in particular glued, on the external face of a corresponding large panel, especially front, 121 of said tag element 12′ of the package 12, and/or preferably is in an upper zone, in use, of the same tag element 12′ of the package, and in any case is preferably positioned above with respect to the perpendicular, or vertical centreline of the same tag element 12′ of the package.

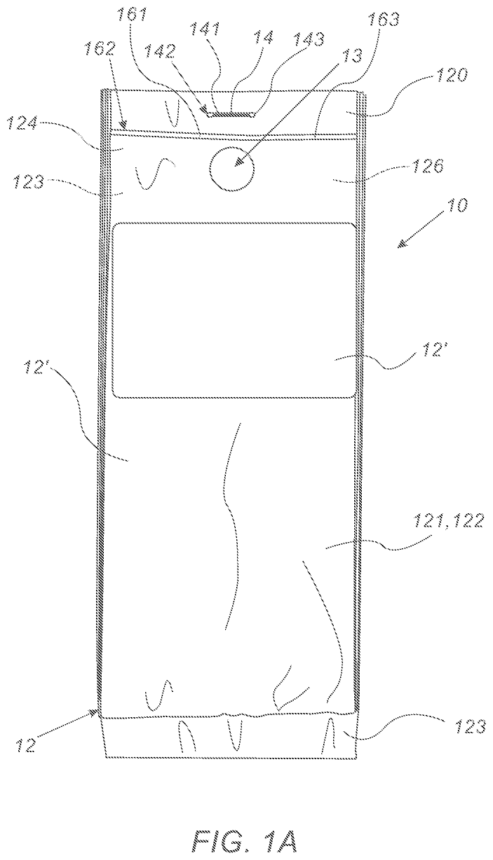

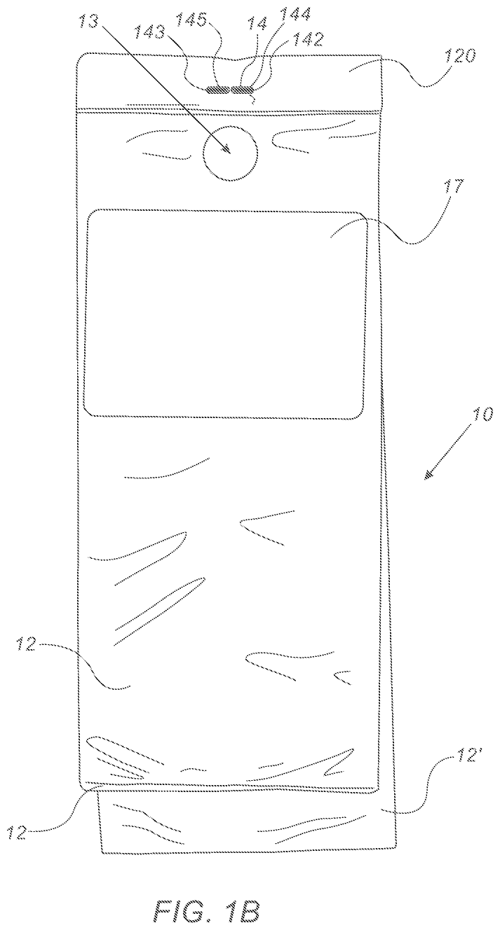

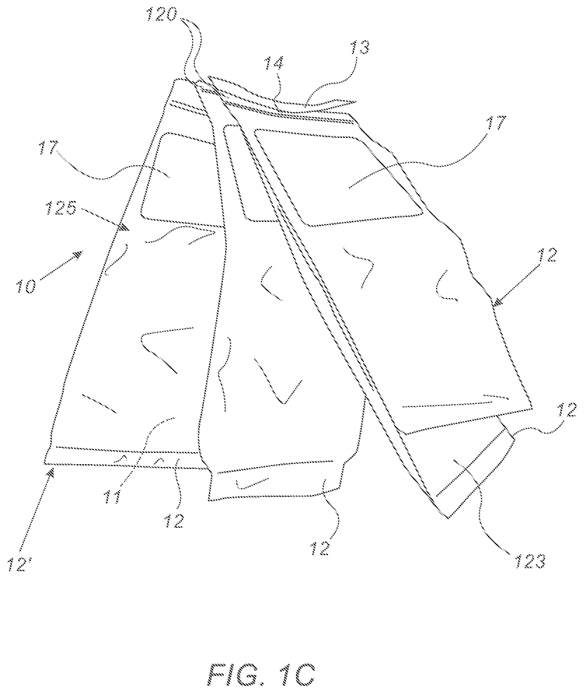

With particular advantage, as can be seen in particular in FIG. 1C, it is provided that the product is housed inside said element of the package, or sachet 12.

Advantageously, as can be seen in FIG. 2, in accordance with a second preferred embodiment, suitable for manufacturing a second preferred embodiment of the package, it is provided that the product, in particular in the form of a box-shaped body containing the respective ingredient, or drug, is supported outside the respective element of the package, or sachet 12, i.e., is fixed, in particular glued, on the external face of a corresponding large panel 121 thereof.

In this way, it is also possible to automatically manage packages of corresponding ingredients or drugs that would not in themselves require repackaging.

Advantageously, as can be seen in FIG. 2, the product, in particular in the form of a box-shaped body containing the respective ingredient, or drug, is supported outside said element of the package, or sachet, 12, i.e., it is fixed, in particular glued, onto the outer face of a corresponding wide panel 121 thereof, in such a position as to not cover the identification label, and in particular being provided, in use, in a position therebelow.

Advantageously, as can be seen in FIG. 2, the product, in particular in the form of a box-shaped body containing the respective ingredient, or drug, is supported protruding, in particular below, from the same element of the package 12.

In this way, the use of an excessive amount of material is avoided for said element of the package 12.

In practice, as is evident, the technical characteristics illustrated above allow, individually or in a respective combination, achieving one or more of the following advantageous results:
it is possible to quickly and easily separate the various elements of the package from each other, in view of a respective easy use of the product or drug contained therein, in particular without the need to have special tools available to perform such an operation;
simply removing the detachable connecting portion, the elements of the package are separated, without having to use special tools to deactivate the connection between the elements of the package;
an attachment can be obtained that can be carried out quickly and easily, as well as particularly inexpensively;
an optimal, balanced and suitably durable attachment can be obtained for said elements of the package;
arranging each element of the package in the same material and in the shape of a sachet, it is advantageously possible to avoid using an excessive number of types of materials on the manufacturing machine of the elements of the package, which would make the machine excessively complex and difficult for staff to manage;
the execution of a precise and accurate detachment of the connecting portion from the rest of the respective element of the package is facilitated;
it is possible to avoid arranging elements of the package which have an excessive length and therefore saving the most amount of material;
the contents of each said element of the package and of the whole package can be known quickly and with certainty;
it is also possible to automatically manage packages of corresponding ingredients or drugs that would not in themselves require repackaging.

The present invention is susceptible to evident industrial application. The person skilled in the art will also be able to imagine numerous modifications and/or variations to be made to the same invention, while remaining within the scope of the inventive concept, as extensively explained. Moreover, the person skilled in the art will be able to imagine further preferred embodiments of the invention which comprise one or more of the above illustrated characteristics of the preferred embodiment. Moreover, it must also be understood that all the details of the invention can be replaced by technically equivalent elements.

1. A package for supporting at least one product, in particular a pharmaceutical product, especially in the form of a package for repackaging said product, and preferably usable within entities, such as hospitals, for the therapeutic care of people; comprising a plurality of elements of the package, in particular in which plurality one or more elements are in the form of respective supporting elements of the product, preferably in the form of a respective sachet; wherein said element of the package has a corresponding portion, in particular outermost, and preferably upper in use, which is adapted to be connected to at least one respective portion of one or more corresponding elements of the package so as to manufacture the same package, said connecting portion being adapted to be detached from the respective element of the package, in particular so as to allow detaching the same element from the remaining part of the package.

2. The package according to claim 1, wherein said element of the package is adapted to contain, or to support, the same product.

3. The package according to claim 1, wherein means for the mutual attachment and retention of the corresponding elements of the package are provided.

4. The package according to claim 3, wherein said mutual attachment and retention means of corresponding elements of the package are applied at the respective detachable connecting portion of the corresponding elements of the package.

5. The package according to claim 3, wherein said mutual attachment and retention means of corresponding elements of the package are in the form of clip means, in particular metal clip means.

6. (canceled)

7. The package according to claim 5, wherein the respective clip is obtained from a respective wire, in particular a metal wire, and preferably comprises a main portion for engagement with the front face of the front element of the package, opposite first and second short portions for insertion into the plurality of said elements of the package, which are perpendicular with respect to said main portion, and opposite first and second convergent portions for engagement with the rear face of the rear element of the package, which first and second convergent portions extend parallel, or substantially parallel, to said main portion of the clip and extend from said first and said second short insertion portions, respectively.

8. The package according to claim 5, wherein said clip means are applied in a central, or substantially central position, according to the transversal direction, to the corresponding elements of the package, i.e., centrally, or substantially centrally, to the corresponding connecting portion.

9. The package according to claim 5, wherein said clip means are provided in perpendicular, or vertical correspondence, with the hole for supporting and handling the package.

10. The package according to claim 1, wherein the element of the package is made of a corresponding film, in particular of a plastic film or a layered film, and is in the form of a sachet, which sachet has wide front and rear panels, a bottom, in particular defined by a welding, especially a transversal welding, between said wide front and rear panels, an upper closure, in particular defined by a welding, especially a transversal welding, between the same wide front and rear panels, and preferably opposite recessed side bellows, extending from said wide front and rear panels.

11. The package according to claim 1, wherein the respective element of the package has means for detaching the respective connecting portion from the same element of the package.

12. The package according to claim 11, wherein said means for detaching said connecting portion are in the form of weakening means, which are obtained in the material constituting the element of the package, said weakening means being preferably in the form of a respective weakened line, in particular transversal, obtained in the respective element of the package.

13. The package according to claim 11, wherein the weakening means, or line, are obtained above, in use, the means for hanging the element of the package and/or above, in use, the upper closure of the sachet or supporting element, in particular defined by the corresponding welding, especially transversal, between the same wide front and rear panels.

14. The package according to claim 11, wherein the weakening means, or line comprise one or more punched sections.

15. The package according to claim 11, wherein the weakening means, or line has a central portion, or section, which is completely cut, or with a clear separation, and on the extension of which opposite first and second punched side portions, or sections are provided; in particular said central cut portion, or section, or with a clear separation, extending to a greater extent than the transversal extension of said hanging means, or hole.

16. The package according to claim 15, wherein said central cut portion, or section, or with a clear separation is near the upper edge of said hanging means, or hole.

17. The package according to claim 1, wherein the respective element of the package has, or supports, a respective identification label.

18. The package according to claim 17, wherein said identification label is fixed, in particular glued, on the outer face of a corresponding wide panel, especially a front one, of said element of the package, and/or is preferably in an upper zone, in use, of the same element of the package, preferably located above with respect to the perpendicular, or vertical centreline, of the same element of the package.

19. The package according to claim 1, wherein an element of the package is provided which is adapted to define, or to support, the identification tag of the whole package and wherein said element of the package, which is adapted to define the package tag, has a greater length than the respective element of the package bearing said product.

20. (canceled)

21. The package according to claim 19, wherein said tag element of the package, which is adapted to define the tag of the same package, is made of a corresponding film, in particular a plastic film or a layered film, and is in the form of a corresponding sachet, onto which an identification label of the package is provided, which is fixed, in particular glued, onto the outer face of a corresponding wide, especially front, panel of said tag element of the package, and/or is preferably in an upper zone, in use, of the same tag element of the package, preferably located above with respect to the perpendicular, or vertical centreline, of the same tag element of the package.

22. The package according to claim 1, wherein it is provided that the product is housed inside said element of the package, or sachet or the product, in particular in the form of a box-shaped body containing the respective ingredient, or drug, is supported outside the respective element of the package, or sachet, i.e., it is fixed, in particular glued, onto the outer face of a corresponding wide panel thereof.

23. (canceled)

24. (canceled)

25. (canceled)

26. (canceled)
